(19) United States
(12) Patent Application Publication
(10) Pub. No.: US 2002/0168508 A1
(43) Pub. Date: Nov. 14, 2002

(54) Medical packaging substrate

(76) Inventors: Amy B. Reed, Marietta, GA (US); Karen H. Bean, Cumming, GA (US)

Correspondence Address: Neil C. Jones, Nelson Mullins Riley & Scarborough, Keenan Building, Third Floor, 1330 Lady Street, Columbia, SC, 29201, US

(21) Appl. No.: 09/976,411

(22) Filed: Oct. 12, 2001

Related U.S. Application Data
(60) Provisional application No. 60/240,184, filed on Oct. 13, 2000.

(51) Int. Cl. B32B 5/14

(52) U.S. Cl. 428/308.8

(57) ABSTRACT

A polymer-impregnated paper-based web for use as a medical packaging bacteria barrier fabric is provided. The use of a particular type of polymer emulsion as the saturant provides the effective range of bacteria filtration while at the same time allowing the web to maintain its enhanced strength and delamination resistance that are required when such substrates are employed to wrap surgical trays, surgical instruments, medical appliances and the like prior to sterilization. The invention consists of a paper-containing medical packaging substrate that has been saturated with a polymer having a glass transition temperature of −20° C. or less.

### CROSS-REFERENCE TO RELATED APPLICATION

This application is a non-provisional of U.S. patent application No. 60/240,184, filed Oct. 13, 2000, and claims priority thereto. In addition, U.S. patent application No. 60/240,184 is specifically incorporated herein in its entirety by reference thereto.

### FIELD OF THE INVENTION

The present invention relates generally to materials useful in forming packages for the medical field, including packaging for medical instruments and other devices that require sterilization. More specifically, the present invention relates to an improved medical packaging substrate having a paper-based web that is polymer-impregnated.

### BACKGROUND OF THE INVENTION

Surgical instruments and various other medical devices must be sterilized prior to use. To reduce the time of operative and other medical procedures and to permit physicians to utilize their skills more efficiently, it has become increasingly common to package surgical tools, medical devices, and medical appliances in a manner in which they are most readily accessible to operating room and medical personnel. The devices are often packaged in a sterile environment so that the devices are immediately available for use. This avoids the older technique of anticipating the various tools and appliances to be used during the surgery and then sterilizing them for use just prior to the operation.

Typically, the containers in which the instruments and devices are packaged are made of a textile or nonwoven fabric that protects the instruments and devices during sterilization processes that may be performed while in the container. (As used herein, the term “fabric” is intended to encompass any sheet-like or web material that is formed in whole or in part from a plurality of fibers.) These is formed in whole or in part from a plurality of fibers.) These packages usually take the form of bags, pouches, or the like. Such containers preserve sterility upon subsequent storage until they are opened and the instruments are used.

The normal sterilization procedure used by most hospitals and surgical supply rooms today involves using sterilizing mediums, such as steam or ethylene oxide gas, to penetrate a porous package in which the surgical instruments or medical devices are housed. The gas flows through pores in the packaging material and sterilizes the instruments contained therein. One well-known method for the sterile packaging of surgical instruments and medical devices has the device sealed within a protective envelope package having at least one portion that is pervious to sterilizing gas, such as ethylene oxide, but which is relatively impervious to the passage of bacteria.

Suitable fabrics for packaging surgical instruments and medical devices typically exhibit the combined effects of good permeability to sterilizing gases and adequate barrier efficacy in order to prevent the entry of bacteria into the package. Generally, cellulosic paper-based webs are sufficiently breathable to allow for gas sterilization techniques but yet sufficiently impervious to prevent certain bacteria, spores, and other microorganisms from passing through.

In addition to being permeable to sterilizing gases and relatively impermeable to bacteria, the fabric should be strong and exhibit relatively high internal bonding, or delamination and tear resistance. Surgical instruments and trays containing various surgical instruments are often sterilized while wrapped in the medical packaging substrates. After sterilization, the storage containers may then be placed on shelves in a storage facility for later transportation to the operating room. Because such storage and transportation may involve the bumping or rubbing of the storage containers against one another, the medical packaging substrates must be strong enough to withstand such handling.

In addition, such fabrics may also possess a certain degree of fluid repellency to prevent further transmission of the bacteria. It is often desired that medical packaging substrates be non-toxic, odorless, lint-free, drapable, supple, smooth, etc. The need for such “touch and feel” characteristics depends on the particular product for which the bacteria barrier fabric is to be used.

The reinforcement of paper by polymer impregnation (commonly referred to as latex saturation) is a long-established practice. The polymer emulsion employed for impregnation is typically a synthetic material and the paper may consist solely of cellulosic fibers or of a mixture of cellulosic and noncellulosic fibers. Such polymer reinforcement improves one or more of dimensional stability, resistance to chemical and environmental degradation, resistance to tearing, embossability, resiliency, conformability, moisture vapor transmission, and abrasion resistance, among others. In addition, saturation of paper-based webs by such emulsions ties down the cellulose fibers so that particulate generation is reduced when the fabric is torn or peeled.

The polymer is normally applied by a saturation process, which involves dipping the formed fabric web into a bath of emulsion or subjecting the fabric web to an emulsion-flooded nip. Alternatively, the webs may be subjected to polymer impregnation while still on the forming wire through the use of various emulsion processes and the like. In either case, the polymer is applied to the fabric after the web has been formed. Such processes where polymer is applied to a formed web are generally referred to herein as “latex saturation” processes, where the term “latex” refers to a synthetic polymer emulsion.

Examples of such latex-saturated substrates include products designated as BP 336 and BP 321 that are available from Kimberly-Clark Corporation. These products are base papers that may be used as medical packaging substrates and comprise various amounts of cellulosic pulps and synthetic latex.

Medical packaging substrates may be formed from either cellulosic fibers alone, synthetic polymeric fibers alone, or a combination of both cellulosic and synthetic fibers. For example, U.S. Pat. No. 5,204,165 to Schortmann discloses a nonwoven laminate having barrier properties that is described as being suitable for industrial, hospital, and other protective or covering uses. The laminate consists of at least one thermoplastic fiber layer bonded with a wet-laid fabric layer made from a uniform distribution of cellulose fibers, polymeric fibers, and a binder. In one embodiment, spunbond polyester fiber layers are ultrasonically bonded on each side of a wet-laid barrier fabric made of eucalyptus fibers and polyester fibers. The barrier fabric is bonded with an acrylic latex binder. The binder is added to the formed polymeric/cellulosic web after the web is formed. The binder may be added by any one of several methods, including foamed emulsion, gravure roll polymer emulsion, spraying, padding and nip-pressure binder pick-up. Schortmann is an example of a barrier fabric formed using a latex saturation process.

Another process for saturating a formed web with a latex binder is disclosed in U.S. Pat. No. 5,595,828 to Weber. A polymer-reinforced paper, which includes eucalyptus fibers, is disclosed. After forming the web from eucalyptus fibers and, optionally, other fibers such as non-eucalyptus cellulosic fibers and/or synthetic fibers, the web is saturated with a latex binder.

Various latex emulsions have been used as binder materials for paper-based webs as well as coating materials for nonwoven webs. Polymeric emulsions of polyacrylates, including polymethacrylates, poly(acrylic acid), poly(methacrylic acid), and copolymers of the various acrylate and methacrylate esters and the free acids; styrene-butadiene copolymers; ethylene-vinyl acetate copolymers; nitrile rubbers or acrylonitrile-butadiene copolymers; poly(vinyl chloride); poly(vinyl acetate); ethylene-acrylate copolymers; vinyl acetate-acrylate copolymers; neoprene rubbers or trans-1,4-polychloroprenes; cis-1,4-polyisoprenes; butadiene rubbers or cis- and trans-1,4-polybutadienes; and ethylene-propylene copolymers have been used to saturate paper-based webs in order to enhance strength and delamination resistance.

Latexes have also been used as barrier coatings to form fluid impervious webs. For example, in U.S. Pat. Nos. 5,370,132 and 5,441,056 to Weber et al. a nonwoven material's surface is first treated with a repellent coating material such as a fluorocarbon. The treated surface is then coated with a barrier coating which may be one of the various latex emulsions. Unlike a saturated web which will have latex particles throughout the web, the described webs in the Weber et al. patent have a surface barrier coating comprising a latex or other barrier material.

Although many latex-saturated webs perform well enough to function as medical packaging barrier substrates, saturating a cellulose paper web with a polymer emulsion to obtain the necessary strength typically results in reduced barrier efficacy. Despite the availability of several alternative bacteria barrier fabrics, a need still exists for further improved medical substrates that can be used in forming bacteria barrier packages. Such substrates should readily allow sterilization materials to enter into the package and sterilize the enclosed appliances while at the same time exhibiting sufficient strength, at least in terms of delamination and tear resistance, to function as medical packaging. In particular, a need exists for maintaining the barrier efficacy of latex-saturated webs without hindering the enhanced strength of these webs resulting from latex-saturation. Any webs that allow for sufficient amounts of latex add-on without decreasing barrier efficacy would be improvements over known latex-saturated substrates used as medical packaging.

### SUMMARY OF THE INVENTION

The present invention overcomes some of the foregoing shortcomings of the prior art by providing a sufficiently strong latex-saturated paper-based web that also exhibits adequate bacteria barrier efficacy to be used for improved medical packaging applications. The use of a particular type of latex as the saturant provides the effective range of bacteria filtration while at the same time allowing the web to maintain its enhanced strength and delamination resistance that are required when such substrates are employed to wrap surgical trays, surgical instruments, medical appliances and the like prior to sterilization.

Generally speaking, the invention consists of a paper-containing medical packaging substrate that has been saturated with a latex having a glass transition temperature of −20° C. or less. Examples of such latex emulsions are certain acrylic latexes sold under the tradename “HyStretch” by Noveon, Inc. of Cleveland, Ohio (formerly B.F. Goodrich Company). In particular, three known acrylic latex saturants that meet these characteristics are Hystretch® V-29, Hystretch® V-43, and Hystretch® V-60. The “V-29”, “V-43”, and “V-60” designations represent the glass transition temperatures of the particular latexes. Thus, Hystretch® V-29 has a glass transition temperature of −29° C.; Hystretch® V-43 has a glass transition temperature of −43° C.; and Hystretch® V-60 has a glass transition temperature of −60° C. and are examples of the latexes that provide the required attributes of the present invention.

### DETAILED DESCRIPTION OF PREFERRED EMBODIMENT

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment.

Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Generally speaking, the present invention is a medical packaging material comprising a cellulose-containing substrate web that has been saturated with a latex having a glass transition temperature of −20° C. or less. More specifically, the present invention involves the saturation of the webs with such low-glass transition temperature latexes in order to improve the barrier efficacy of the web.

Conventional latex saturants, when employed at the add-on levels required to obtain the necessary increased strength characteristics, tend to reduce the barrier efficacy of medical packaging substrate webs. It is believed that the efficacy is reduced because the number of tortuous pathways, which entrap microorganisms within the web, are reduced by polymer saturation. The particular latexes having glass transition temperatures of −20° C. and below have been found to actually improve the percent bacterial filtration efficiency (“%BFE”) and log reduction value (“LRV”), both common industry determinations of barrier efficacy, of latex-saturated paper as compared to latex-saturated papers that have not utilized these particular latexes.

For example, the latex-saturated webs of the present invention will generally exhibit higher %BFEs and LRVs than comparable latex-saturated webs. Generally, the higher the estimated %BFE or LRV, the greater the bacteria barrier properties. For example, an LRV change from 1 to 2 indicates a ten times improvement in the barrier.

The paper-based webs of the present invention may be formed from cellulosic pulp fibers alone, or a mixture of cellulosic pulp and synthetic fibers. As used herein, the terms “cellulosic-based” and “paper-based” may be used interchangeably and refer to webs that contain cellulosic fibers. The cellulosic pulp fiber component of the furnish for making the bacteria barrier web may include various woody and/or non-woody cellulosic fiber pulps. Pulp includes fibers from natural sources such as woody and non-woody plants. Woody plants include, for example, deciduous and coniferous trees. Non-woody plants include, for example, cotton, flax, esparto grass, milkweed, straw, jute hemp, and bagasse.

The pulp may be a mixture of different types and/or qualities of pulp fibers. For example, the invention may include a pulp containing more than about 50 percent by weight, low-average fiber length pulp and less than about 50 percent by weight, high-average fiber length pulp (e.g., virgin softwood pulp). The low-average fiber length pulp may be characterized as having an average fiber length of less than about 1.2 mm. For example, the low-average fiber length pulp may have a fiber length of from about 0.7 mm to about 1.2 mm. The high-average fiber length pulp may be characterized as having an average fiber length of greater than about 1.5 mm. For example, the high-average fiber length pulp may have an average fiber length of from about 1.5 mm to about 6 mm. The fiber mixture may contain about 75 percent, by weight, low-average fiber length pulp and about 25 percent, by weight, high-average fiber length pulp.

The low-average fiber length pulp may be certain grades of virgin hardwood pulp and secondary (i.e., recycled) fiber pulp from sources such as, for example, newsprint, reclaimed paperboard, and office waste. The high-average fiber length pulp may be bleached and/or unbleached virgin softwood pulps.

In accordance with the present invention, any of the various wood and nonwood pulps and other cellulosic fibers may be incorporated into the pulp furnish. Illustrative examples of suitable lignocellulosic pulps include southern pines, northern softwood pulps, red cedar, hemlock, black spruce and mixtures thereof. Some such high-average fiber length wood pulps include those available under the trade designations LL19 available from Kimberly-Clark Corporation and International Pine® available from International Paper Company.

Other various cellulosic fibers that may be used in the present invention include eucalyptus fibers, such as Primacell Eucalyptus available from Klabin Riocell, and other hardwood pulp fibers available under the trade designations LL16 available from Kimberly-Clark Corporation, St. Croix hardwood available from Georgia-Pacific Corporation, and Leaf River hardwood available from Georgia-Pacific Corporation. Obviously, other cellulosic fibers may be utilized in the present invention, depending on the particular characteristics desired.

Refinement of the pulp may be conducted in order to improve the properties necessary to use the web as a bacteria barrier. In particular, refinement of the pulp may be carried out by beating or otherwise agitating the cellulosic material until the material is sufficiently separated into relatively individual pulp fibers. Such refinement may be carried out by any number of various known methods such as in commercial grade pulp refiners. Such refining processes are within the known skill in the art and often improve the bacteria filtration efficiencies of webs made from highly refined pulp.

The furnish may also include synthetic fibers such as rayon fibers, polyvinyl alcohol fibers, ethylene vinyl alcohol copolymer fibers, and various polyolefin fibers. Suitable polymeric fibers for use in the present invention include fibers made from polyolefins, polyesters, polyamides, and copolymers and blends thereof. Polyolefins suitable for the fibers include polyethylene, e.g., high density polyethylene, medium density polyethylene, low density polyethylene and linear low density polyethylene; polypropylene, e.g., isotactic polypropylene, syndiotactic polypropylene, blends thereof, and blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Polyamides suitable for the fibers include nylon 6, nylon 6/6, nylon 4/6, nylon 11, nylon 12, nylon 6/10, nylon 6/12, nylon 12/12, copolymers of caprolactam and alkaline oxide diamine, and the like, as well as blends and copolymers thereof. Suitable polyesters include polyethylene terephthalate, polybutylene terephthalate, polytetramethylene terephthalate, polycyclohexylene-1,4-dimethylene terephthalate, and isophthalate copolymers thereof, as well as blends thereof. Of these suitable polymers, more desirable polymers are polyolefins, most desirably polyethylene and polypropylene, because of their commercial availability, as well as their chemical and mechanical properties.

In addition, bicomponent fibers may be utilized in addition to the cellulosic fibers and unitary synthetic. Bicomponent fibers are multicomponent fibers wherein two fibers having differing characteristics are combined into a single fiber. Bicomponent fibers generally have a core and sheath structure where the core polymer has a higher melting point than the sheath polymer. In one embodiment, bicomponent fibers may have a polyester core and a polyolefin sheath. Other bicomponent fiber structures, however, may also be utilized. For example, bicomponent fibers may be formed with the two components residing in various side-by-side relationships as well as concentric and eccentric core and sheath configurations.

When used, bicomponent fibers aid in increasing the strength of the web. The outer sheath of the bicomponent fiber should be capable of adhering to cellulosic fibers so that the structure of the web is reinforced through their use. One particular example of a suitable bicomponent fiber is sold under the name Celbond® T255 by KoSa. Celbond® T255 is a synthetic polyester/polyethylene bicomponent fiber that is capable of adhering to cellulosic fibers when its outer sheath is melted at a temperature of approximately 128° C.

In making the web of the present invention, a pulp furnish is formed according to normal paper-making or web-making procedures. Briefly, and by way of illustration only, the substrate may be made by preparing an aqueous suspension of fibers with at least about 50 percent, by dry weight, of the fibers being cellulosic fibers; distributing the suspension on a forming wire; removing water from the distributed suspension to form a paper; and then treating the paper with the saturant. In general, the aqueous suspension is prepared by methods well known to those having ordinary skill in the art. Similarly, methods of distributing the suspension on a forming wire and removing water from the distributed suspension to form a paper also are well known to those having ordinary skill in the art.

In addition to noncellulosic fibers, the aqueous pulp-containing suspension from which the substrates are made may contain other materials as is well known in the papermaking art. For example, the suspension may contain acids and bases to control pH, such as hydrochloric acid, sulfuric acid, acetic acid, oxalic acid, phosphoric acid, phosphorous acid, sodium hydroxide, potassium hydroxide, ammonium hydroxide or ammonia, sodium carbonate, sodium bicarbonate, sodium dihydrogen phosphate, disodium hydrogen phosphate, and trisodium phosphate; alum; sizing agents, such as rosin and wax; dry strength adhesives, such as natural and chemically modified starches and gums; cellulose derivatives such as carboxymethyl cellulose, methyl cellulose, and hemicellulose; synthetic polymers, such as phenolics, latexes, polyamines, and polyacrylamides; wet strength resins, such as urea-formaldehyde resins, melamine-formaldehyde resins, and polyamides; fillers, such as clay, talc, and titanium dioxide; coloring materials, such as dyes and pigments; retention aids; fiber deflocculants; soaps and surfactants; defoamers; drainage aids; optical brighteners; pitch control chemicals; slimicides; and specialty chemicals, such as corrosion inhibitors, and flame-proofing agents.

In addition to the use of the particular polymers disclosed herein, other binder materials may be used in forming the present webs. For example, the additional binder materials may be used as an additional constituent of the saturant in conjunction with the polymers having the specific glass transition temperatures set forth herein. On the other hand, such binder materials may be used at various points in the web-forming or web-saturating process to add additional strength or filtration characteristics to the web.

Any of the latex binders commonly employed for reinforcing paper can be utilized and are well known to those having ordinary skill in the art. Suitable binders include, by way of illustration only, polyacrylates, including polymethacrylates, poly(acrylic acid), poly(methacrylic acid), and copolymers of the various acrylate and methacrylate esters and the free acids; styrene-butadiene copolymers; ethylene-vinyl acetate copolymers; nitrile rubbers or acrylonitrile-butadiene copolymers; poly(vinyl chloride); poly(vinyl acetate); ethylene-acrylate copolymers; vinyl acetate-acrylate copolymers; neoprene rubbers or trans-1,4-polychloroprenes; cis-1,4-polyisoprenes; butadiene rubbers or cis- and trans-1,4-polybutadienes; and ethylene-propylene copolymers.

Specific examples of commercially available latex binders are set forth as examples in Table 1 below:

TABLE 1

| Polymer Type | Product Identification |
|---|---|
| Polyacrylates | Hycar ® 26083, |
| | 26084, 26120, 26104, 26106, |
| | 26322, 26410, 26469 |
| | Noveon, Inc. |
| | Cleveland, Ohio |
| | Rhoplex ® HA-8, HA-12, HA-16 |
| | NW-1715, B-15 |
| | Rohm and Haas Company |
| | Philadelphia, Pennsylvania |
| | Carboset ® XL-52 |
| | Noveon, Inc. |
| | Cleveland, Ohio |
| Styrene-butadiene copolymers | Butofan ® 4264, 4262 |
| | BASF Corporation |
| | Charlotte, North Carolina |
| | DL 219NA, DL 239NA |
| | Dow Chemical Company |
| | Midland, Michigan |
| Nitrile rubbers | Hycar ® 1572, 1577, 1570X55, |
| | 1562X28 |
| | Noveon, Inc. |
| | Cleveland, Ohio |
| Poly(vinyl chloride) | Vycar ® 352, 552 |
| | Noveon, Inc. |
| | Cleveland, Ohio |
| Ethylene-acrylate copolymers | Michem ® Prime 4990, 4983R |
| | Michelman, Inc. |
| | Cincinnati, Ohio |
| | Adcote ® 56220 |
| | Rohm & Haas Company |
| | Philadelphia, Pennsylvania |
| Vinyl acetate-acrylate | Xlink ® 2833 |
| copolymers | Vinamul ™ Polymers |
| | Bridgewater, New Jersey |

Various other additives may also be used in forming the bacteria barrier substrate. For example, sizing agents to impart water resistance, wet-strength agents to improve delamination resistance, and other agents may be added either to the furnish or to the formed web. One such exemplary sizing agent is Aquapel® 752 available from Hercules Incorporated of Wilmington, Del., and one such exemplary wet-strength agent is Parez® 607L available from Cytec Industries, Inc. of West Paterson, N.J. Other agents, include, by way of example only, starches and dry-strength resins which also enhance the physical properties of the web by increasing the delamination resistance of the final product. One such exemplary starch is a cationic potato starch sold under the designation Astro® X-200 and one such exemplary dry-strength resin is Accostrength® 85-P HP from Cytec Industries. Another exemplary dry-strength resin is Accostrength® 3000. Cross-linking agents, such as X-Link® 2833 from Vinamul™ Polymers and XAMA®7 from Sybron Chemicals, Inc. of Birmingham, N.J., and/or hydrating agents may also be added to the pulp furnish or to the formed web.

After the web is formed, the web will then be saturated with the polymer emulsion having a glass transition temperature of −20° C. or below. As used herein, the term “saturant” is synonymous with the term “binder” and is meant to include any polymeric material which may be used to bind the fibers of the fibrous web or nonwoven substrate together. The saturant may be applied as either a solution of a polymer in a suitable solvent or as a dispersion of very small polymer particles in a liquid phase, such as water, e.g., as a latex. For example, the saturant may be any of the latex binders commonly employed for reinforcing papers, provided such latex has a glass transition temperature of −20° C. or less. In particular, the acrylic latexes, which are polyacrylates, meeting this glass transition temperature threshold are particularly useful as the saturants for such medical packaging fabrics. In addition, saturant blends comprising more than one latex binder may be employed. In these blended saturant formulations, one or more of the latexes may have a glass transition temperature of greater than −20° C., provided that one or more latexes with glass transition temperatures of −20° C. or less comprise at least 50% of the saturant by dry weight.

Various latex binders are well known to those having ordinary skill in the art and include, by way of illustration only, polyacrylates, including polymethacrylates, poly(acrylic acid), poly(methacrylic acid), and copolymers of the various acrylate and methacrylate esters and the free acids; styrene-butadiene copolymers and carboxylated versions thereof; ethylene-vinyl acetate copolymers; nitrile rubbers or acrylonitrile-butadiene copolymers; poly(vinyl chloride); poly(vinyl acetate); ethylene-acrylate copolymers; vinyl acetate-acrylate copolymers; neoprene rubbers or trans-1,4-polychloroprenes; cis-1,4-polyisoprenes; butadiene rubbers or cis- and trans-1,4-polybutadienes; and ethylenepropylene copolymers.

In particular, the acrylic latexes such as the above-described polyacrylates tend to provide the desired features of the present invention. While other binder systems may provide adequate strength in the latex-saturated webs, the polyacrylate saturants exhibit the most desirable bacterial filtration efficiencies.

The saturation of a fabric is well known in the art and a fabric may be saturated, for example, by spraying the saturant solution onto one or both sides of the web. Saturation of the fabric may also be accomplished by dipping the web into a bath of saturant and removing the excess liquid by passing the web through a nip roller arrangement. Other saturating methods include brushing and doctor blading and the present invention is not limited to any particular saturating process.

If desired, the paper may be dried after the web is formed and prior to treatment of the paper with the saturant. Drying of the paper may be accomplished by any known means. Examples of known drying means include, by way of illustration only, convection ovens, radiant heat, infrared radiation, forced air ovens, and heated rolls or cans. Drying also includes air drying without the addition of thermal energy, other than that present in the ambient environment.

In one particular method of saturating the web, the web is exposed to an excess of saturant and then squeezed so as to control the amount of material added on to the web. The squeezing of excess saturant from the web may be accomplished by passing the web between rollers. In the process, excess, squeezed-out, saturant may be returned to the supply for further use.

After squeezing out excess material to control the saturant add-on, the saturated web may then be dried. Drying may be achieved by passing the fabric around a series of steam heated drums at a temperature appropriate for the particular saturant composition being used. Alternatively, the web material impregnated with saturant can be air-dried.

The web will typically be saturated at an add-on level of from about 10 to about 100 percent, based on the dry weight of the fibrous web. For example, the saturant may be present in the saturated paper at a level of from about 20 to about 70 percent. As another example, the saturant may be present in the saturated paper at a level of from about 30 to about 60 percent.

Saturant total solids in the saturant composition may range from 10 to 60 weight percent, depending on the desired dry saturant pickup. Dry pickup ranges from 10 to 80 dry parts of saturant per 100 dry parts of fibrous web material by weight. Particularly satisfactory ranges of dry pickup are from 20 to 70 dry parts of saturant per 100 dry parts of fibrous web, and saturant total solids in a range of 20 to 50 weight percent in the saturant composition are used. In other embodiments, the dry pickup may be from about 30 to about 50 dry parts, or from about 40 to about 50 dry parts, of saturant per 100 dry parts of fiber in the web. Wet saturant pickup can range from about 40 to about 300 wet parts per 100 parts of fibrous web material by weight.

The expressions “by dry weight”, “dry parts”, and “based on the dry weight” refer to weights of fibers, e.g., cellulosic fibers, or other materials which are essentially free of water in accordance with standard practice in the papermaking art. When used, such expressions mean that weights were calculated as though no water were present.

A particularly effective saturant may include from about 60 to about 100 percent, on a dry weight basis, of a latex reinforcing polymer (or a blend of latex reinforcing polymers) having a glass transition temperature of −20° C. or less and from about 0 to about 40 percent filler or pigment, with about 10 to about 30 percent filler or pigment being desirable in some embodiments. Additionally, crosslinking agents, sizing agents, lubricants, antifoaming agents, and acids and bases may comprise about 0 to about 15 percent of the saturant, with about 0.1 to about 15 percent of the saturant being desirable in some embodiments.

After formation of the polymer-impregnated substrate, the fabric is then supplied to a maker of medical packaging. The packager then transforms the fabric into the appropriate packaging necessary for storing medical devices and appliances and surgical instrumentation. Such medical packaging may take the form of sterile wraps for encasing surgical instrument trays, bags, pouches, or other sterilizable containers.

### EXAMPLES

The present invention may be understood by reference to the following Examples, without being limited thereto. The Examples were performed in order to demonstrate the bacteria filtration efficiency enhancement in fibrous structures.

Various base papers were saturated with latex compositions having various glass transition temperatures. The particular latexes were added-on at a rate of from about 30 to about 50 dry parts per 100 dry parts fiber in each case. Table 3 below indicates, with respect to each Example, the basis weight of the base paper, a description of the base paper composition and saturating emulsion composition, the glass transition temperature of the saturant, the Gurley Porosity (which indicates the porosity or permeability of the sheet), the Bacteria Filtration Efficiency (% BFE) and the Log Reduction Value (“LRV”) (for some of the samples only).

Each of the samples was prepared by blending and refining the indicated amounts of cellulosic fibers in an aqueous slurry. Noncellulosic fibers were added to the slurry after refining. The fiber slurries were then deposited on a forming fabric or wire and the water was removed. The resulting formed web was dried prior to treatment by polymer emulsion. The polymer emulsion was applied in each case by exposing the web to an excess of saturant in a flooded nip. The excess material was removed in the nip. The saturated sheet was then dried and steel-calendered at about 150 pounds per linear inch (“PLI”) prior to testing.

The porosity of the saturated sheets was determined according to the Gurley Hill Porosity test pursuant to TAPPI Test Method T460om-96. The basis weight was determined by TAPPI Test Method T410om-98 and is reported in grams per square meter.

The Bacterial Filtration Efficiency (“BFE”) of the saturated substrates was determined by employing a ratio of the bacterial challenge counts to sample effluent counts, which yields the percent bacterial filtration efficiency (“% BFE”). The BFE test described below was performed by Nelson Laboratories (Salt Lake City, Utah). A culture of Staphylococcus aureus was diluted in 1.5% peptone water to a precise concentration to yield challenge level counts of 2200 ±500 colony forming units (“CFU”) per test sample. The bacterial culture suspension was pumped through a nebulizer at a controlled flow rate and fixed air pressure. The constant challenge delivery, at a fixed air pressure, formed aerosol droplets with a mean particle size (“MPS”) of approximately 3.0 microns. The aerosol droplets were generated in a glass aerosol chamber and drawn through a six-stage, viable particle, Andersen sampler for collection. The collection flow rate through the test sample and Andersen sampler was maintained at 28.3 LPM (1 CFM). Test controls and test samples were challenged for a two-minute interval.

The delivery rate of the challenge also produced a consistent challenge level of 2200 ±500 CFU on the test control plates. A test control (no filter medium in the airstream) and reference material are included after 7-10 test samples. The Andersen sampler, a sieve sampler, impinged the aerosol droplets onto six agar plates based on the size of each droplet. The agar medium used was soybean casein digest agar (SCDA). The agar plates were incubated at 37° C. ±2° C. for 48 hours ±4 hours, with shaking, and the colonies formed by each bacteria-laden aerosol were droplet counted and converted to probable hit values using the hole conversion chart provided by Andersen. These converted counts were used to determine the average challenge level delivered to the test samples. The distribution ratio of colonies for each of the six agar plates were used to calculate the MPS of the challenge aerosol.

The filtration efficiencies were calculated as a percent difference between test sample runs and the control average using the following equation:

$$\frac{C - T}{C} \times 100 = \% BFE$$

Where:

C=Average of control values; and

T=Count total for test material.

The measurement, %BFE, has an upper limit of 100%, indicating 100% of the microorganisms were intercepted by the test material.

Bacteria Spore Penetration is measured according to ASTM F 1608-95. According to this test method, a sheet sample is exposed to an aerosol of Bacillus subtilis var. niger spores for 15 minutes at a flow rate through the sample of 2.8 liters/minute. Spores passing through the sample are collected on a media and are cultured and the number of colony-forming units (“CFU”) is measured. The log reduction value (“LRV”) expresses the difference, measured in log scale, between the number of CFU on the control media and the number of CFU on the media that was behind the sample. This ability to resist passage of microorganisms is calculated according to the following equation:

LRV=log₁₀N₀−log₁₀N₁

Where:

N₀=average bacterial challenge determined from the challenge control filter, CFU; and

N₁=average number of bacteria passing through Test Sample 1, CFU. If N₁<1, then LRV is expressed as >log₁₀N₀.

For example, an LRV of 5 represents a difference of 100,000 cluster forming units.

The range of measurable LRV is 0 to 5, where a greater number indicates the likelihood of greater barrier efficacy (as measured by this test). Ethox Corporation performed the LRV determinations.

TABLE 3

| | | | Glass | | | |
|---|---|---|---|---|---|---|
| | Basis | | Transition | Gurley | | |
| | Weight | Description of Base Paper and Saturant | Temperature | Porosity | % | |
| EXAMPLE | (g/m²) | Composition | (° C.) | (sec/100 cc) | BFE | LRV |
| 1 | 84.6 | High porosity base comprised of 78.4% Northern | −5 | 6 | 81 | 1.3 |
| | | (“N.”) softwood fiber, 21.6% hardwood fiber, | | | | |
| | | saturated with Rhoplex ® B-15 acrylic polymer | | | | |
| 2 | 84.6 | High porosity base comprised of 78.4% N. | −29 | 9 | 93.1 | |
| | | softwood fiber, 21.6% hardwood fiber, saturated | | | | |
| | | with HyStretch ® V-29 acrylic polymer | | | | |
| 3 | 84.6 | High porosity base comprised of 78.4% N. | −43 | 7 | 96.2 | 1.7 |
| | | softwood fiber, 21.6% hardwood fiber, saturated | | | | |
| | | with HyStretch ® V-43 acrylic polymer | | | | |
| 4 | 114 | Low porosity base comprised of 56.5% N. softwood | −5 | 20 | 97.7 | |
| | | fiber, 43.5% eucalyptus fiber, saturated with | | | | |
| | | Rhoplex ® B-15 acrylic polymer | | | | |
| 5 | 114 | Low porosity base comprised of 56.5% N. softwood | −43 | 15 | 99.9 | |
| | | fiber, 43.5% eucalyptus fiber, saturated with | | | | |
| | | HyStretch ® V-43 acrylic polymer | | | | |
| 6 | 73.3 | High porosity base comprised of 60.3% eucalyptus | −43 | 2 | 97.4 | |
| | | fiber, 29.7% N. softwood fiber, 10% low density | | | | |
| | | polyethylene/polypropylene (“LDPE/PP”) fiber, | | | | |
| | | saturated with HyStretch ® V-43 | | | | |
| 7 | 84.5 | High porosity base comprised of 60.3% eucalyptus | 8 | 8 | 88 | |
| | | fiber, 29.7% N. softwood fiber, 10% LDPE/PP fiber, | | | | |
| | | saturated with Hycar ® 26084 acrylic polymer | | | | |
| 8 | 84.5 | High porosity base comprised of 60.3% eucalyptus | −11 | 8.6 | 90 | |
| | | fiber, 29.7% N. softwood fiber, 10% LDPE/PP fiber, | | | | |
| | | saturated with Hycar ® 26410 acrylic polymer | | | | |
| 9 | 84.5 | High porosity base comprised of 60.3% eucalyptus | −15 | 11.7 | 92.8 | |
| | | fiber, 29.7% N. softwood fiber, 10% LDPE/PP fiber, | | | | |
| | | saturated with Hycar ® 26703 acrylic polymer | | | | |
| 10 | 84.5 | High porosity base comprised of 60.3% eucalyptus | −5 | 7.5 | 90.4 | |
| | | fiber, 29.7% N. softwood fiber, 10% LDPE/PP fiber, | | | | |
| | | saturated with Rhoplex ® B15 acrylic polymer | | | | |
| 11 | 84.5 | High porosity base comprised of 78.4% N. | −43 | 8 | 96.9 | |
| | | softwood fiber, 21.6% hardwood fiber, saturated | | | | |
| | | with HyStretch ® V-43 acrylic polymer | | | | |

As can be seen in Table 3, the acrylic polymers sold under the “Hystretch” tradename are particularly useful in forming the medical packaging substrate of the present invention. In particular, where the Gurley Hill porosity is high (such as 15 sec/100 cc), the use of a Hystretch® acrylic polymer saturant having a glass transition temperature of −20° C. or less can result in a highly efficient bacterial filtration fabric.

The various Hystretch® polymers employed in the Examples above have the following characteristics indicated in Table 4:

TABLE 4

| | | | | Glass | |
|---|---|---|---|---|---|
| | | | | Transition | |
| | Total | | Viscosity | Temperature | Specific |
| Acrylic Polymer | Solids (%) | pH | (cP) | (° C.) | Gravity |
| Hystretch ® V-60 | 50 | 8.0 | 40 | −60 | 1.01 |
| Hystretch ® V-43 | 50 | 8.0 | 200 | −43 | 1.03 |
| Hystretch ® V-29 | 49 | 8.0 | 70 | −29 | 1.04 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the preferred versions contained therein.

What is claimed is:

1. A medical packaging substrate comprising a polymer-impregnated paper-based web, said polymer-impregnated paper-based web being saturated with a saturant comprising a polymer emulsion having a glass transition temperature of −20° C. or less.

2. The medical packaging substrate of claim 1 wherein said polymer emulsion has a glass transition temperature of about −29° C. or less.

3. The medical packaging substrate of claim 1 wherein said polymer emulsion has a glass transition temperature of about −43° C. or less.

4. The medical packaging substrate of claim 1 wherein said polymer emulsion has a glass transition temperature of about −60° C. or less.

5. The medical packaging substrate of claim 1 wherein said polymer emulsion is added on to said polymer-impregnated paper-based web at a rate of between about 20 and about 60 dry parts per 100 dry parts of fiber in the polymer-impregnated paper-based web.

6. The medical packaging substrate of claim 1 wherein said polymer emulsion is added on to said polymer-impregnated paper-based web at a rate of between about 30 and about 50 dry parts per 100 dry parts of fiber in the polymer-impregnated paper-based web.

7. The medical packaging substrate of claim 1 wherein said polymer emulsion comprises a polyacrylate.

8. The medical packaging substrate of claim 1 wherein said polymer emulsion comprises a blend of a polyacrylate and a polymer that is not a polyacrylate.

9. The medical packaging substrate of claim 1 wherein said saturant comprises an additional polymer emulsion.

10. The medical packaging substrate of claim 9 wherein said additional polymer emulsion has a glass transition temperature of −20° C. or less.

11. The medical packaging substrate of claim 9 wherein said additional polymer emulsion has a glass transition temperature of about −29° C. or less.

12. The medical packaging substrate of claim 9 wherein said additional polymer emulsion has a glass transition temperature of about −43° C. or less.

13. The medical packaging substrate of claim 9 wherein said additional polymer emulsion has a glass transition temperature of about −60° C. or less.

14. A medical packaging substrate comprising a polymer-impregnated paper-based web, said polymer-impregnated paper-based web having a Gurley Hill porosity of less than about 9 sec/100 cc, said polymer-impregnated paper-based web being saturated with a polymer emulsion having a glass transition temperature of −20° C. or less, and wherein said polymer-impregnated paper-based web exhibits a %BFE of at least about 92%.

15. A medical packaging substrate comprising a polymer-impregnated paper-based web, said polymer-impregnated paper-based web having a Gurley Hill porosity of greater than about 15 sec/100 cc, said polymer-impregnated paper-based web being saturated with a polymer emulsion having a glass transition temperature of −20° C. or less, and wherein said polymer-impregnated paper-based web exhibits a %BFE of at least about 95%.

16. A medical packaging substrate comprising a polymer-impregnated paper-based web, said polymer-impregnated paper-based web having a Gurley Hill porosity of greater than about 15 sec/100 cc, said polymer-impregnated paper-based web being saturated with a polymer emulsion having a glass transition temperature of −20° C. or less, and wherein said polymer-impregnated paper-based web exhibits a %BFE of at least about 98%.

17. A medical packaging substrate according to claim 16 wherein said polymer-impregnated paper-based web exhibits a %BFE of at least about 99%.

18. A medical packaging substrate comprising a polymer-impregnated paper-based web, said polymer-impregnated paper-based web having a Gurley Hill porosity of greater than about 15 sec/100 cc, said polymer-impregnated paper-based web being saturated with at least two polymer emulsions wherein at least one of said polymer emulsions has a glass transition temperature of −20° C. or less, and wherein said polymer-impregnated paper-based web exhibits a %BFE of at least about 98%.

19. The medical packaging substrate of claim 18 wherein one of said at least two polymer emulsions has a glass transition temperature of about −43° C. or less.

20. The medical packaging substrate of claim 19 wherein both of said at least two polymer emulsions have a glass transition temperature of about −43° C. or less.
